(19) United States
(12) Patent Application Publication
(10) Pub. No.: US 2004/0094000 A1
(43) Pub. Date: May 20, 2004

(54) Screwdriver handle having a storage structure

(76) Inventor: Yung-Chyuan Liao, Taichuang (TW)

Correspondence Address: Yuan-Chyuan Liao, P.O. BOX 65-45, Taichuang, 403, TW

(21) Appl. No.: 10/303,115

(22) Filed: Nov. 20, 2002

(51) Int. Cl. B25G 1/08

(52) U.S. Cl. 81/490

(57) ABSTRACT

A screwdriver handle includes a front shank and a rear shank combined with each other. The receiving seat of the rear shank is formed with a plurality of receiving holes for receiving multiple screwdriver heads and sockets, thereby enhancing the storage space of the screwdriver handle. In addition, when one of the plurality of receiving holes of the rear shank aligns with the push block, the screwdriver head or the socket received in the respective receiving hole is pushed upward by the push block, thereby facilitating the user taking and using the screwdriver head or the socket. Further, the slideway of the rear shank has two closed ends to limit detachment of the guide rail of the front shank, thereby preventing the rear shank from detaching from the front shank.

### BACKGROUND OF THE INVENTION

1. Field of the Invention

The present invention relates to a screwdriver handle having a storage structure, and more particularly to a screwdriver handle having a storage structure, thereby enhancing the storage space of the screwdriver handle.

2. Description of the Related Art

A conventional screwdriver handle comprises a screwdriver head and a shank detachably mounted on the head. Thus, the shank may be used to drive the screwdriver heads of different sizes. However, the screwdriver heads are placed in the tool box, so that the user has to carry the tool box, thereby causing inconvenience to the user

### SUMMARY OF THE INVENTION

The present invention has arisen to mitigate and/or obviate the disadvantage of the conventional screwdriver handle.

The primary objective of the present invention is to provide a screwdriver handle having a storage structure, wherein the receiving seat of the rear shank is formed with a plurality of receiving holes for receiving multiple screwdriver heads and sockets, thereby enhancing the storage space of the screwdriver handle.

Another objective of the present invention is to provide a screwdriver handle having a storage structure, wherein when one of the plurality of receiving holes of the receiving seat of the rear shank aligns with the push block, the screwdriver head or the socket received in the respective receiving hole is pushed upward by the push block, thereby facilitating the user taking and using the screwdriver head or the socket.

A further objective of the present invention is to provide a screwdriver handle having a storage structure, wherein each of the plurality of positioning grooves of the rear shank is used for positioning the positioning ball of the push block, thereby positioning the rear shank on the front shank temporarily.

A further objective of the present invention is to provide a screwdriver handle having a storage structure, wherein the slideway of the rear shank has two closed ends to limit detachment of the guide rail of the front shank, thereby preventing the rear shank from detaching from the front shank.

A further objective of the present invention is to provide a screwdriver handle having a storage structure, wherein the positioning ball of the first lug of the rear shank is urged on the wall of the receiving chamber of the front shank, thereby preventing the rear shank from detaching from the front shank.

A further objective of the present invention is to provide a screwdriver handle having a storage structure, wherein the first lug and the second lug of the rear shank are rested on the wall of the receiving chamber of the front shank, so that the rear shank is slidable on the front shank rigidly and stably, thereby facilitating operation of the user.

In accordance with the present invention, there is provided a screwdriver handle having a storage structure, comprising a front shank, and a rear shank combined with the front shank, wherein:

the front shank is formed with an axially extended receiving chamber, the receiving chamber of the front shank has a bottom formed with a protruding guide rail; and

the rear shank is mounted on the front shank, and has a receiving seat inserted into the receiving chamber of the front shank, the receiving seat of the rear shank is formed with a plurality of receiving holes for receiving screwdriver heads and sockets, the receiving seat of the rear shank has a bottom formed with a slideway slidably mounted on the guide rail of the front shank and communicated with the plurality of receiving holes.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a screwdriver handle having a storage structure in accordance with a preferred embodiment of the present invention;

FIG. 2 is a partially exploded perspective view of the screwdriver handle having a storage structure in accordance with the preferred embodiment of the present invention;

FIG. 3 is a side plan cross-sectional assembly view of the screwdriver handle having a storage structure as shown in FIG. 1; and

FIG. 4 is a schematic operational view of the screwdriver handle having a storage structure as shown in FIG. 3 in use.

### DETAILED DESCRIPTION OF THE INVENTION

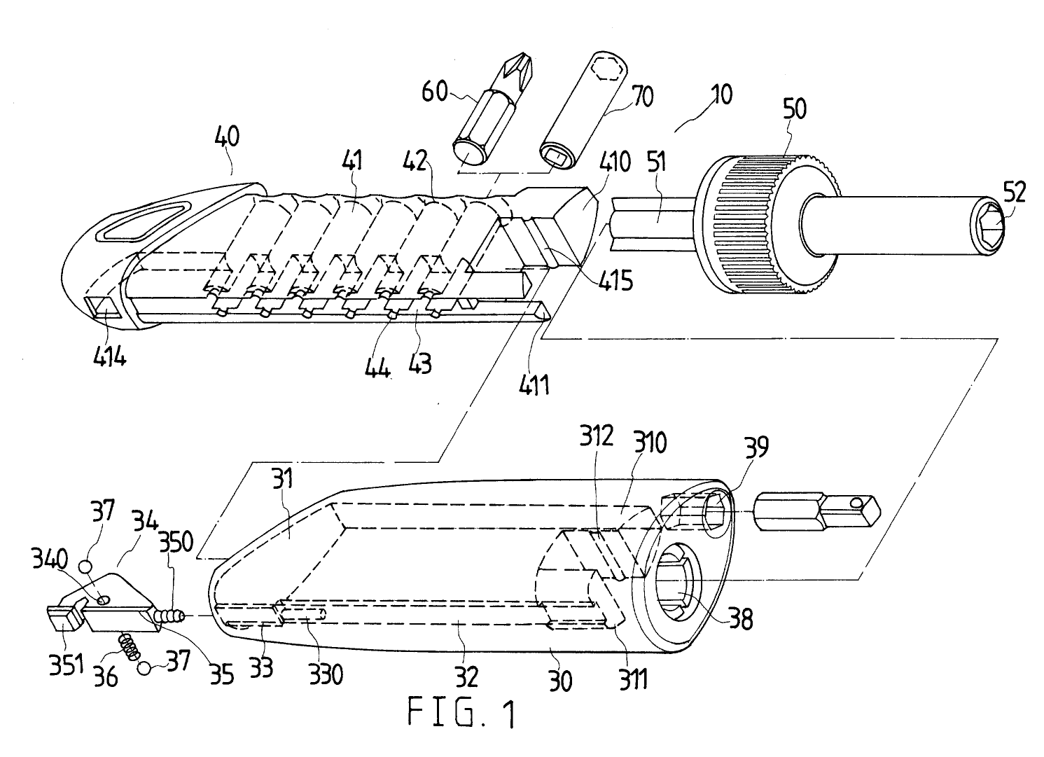

Referring to the drawings and initially to FIGS. 1-3, a screwdriver handle 10 having a storage structure in accordance with a preferred embodiment of the present invention comprises a front shank 30, and a rear shank 40 combined with the front shank 30.

The front shank 30 has an end face formed with an insertion hole 38 and a receiving hole 39 located beside the insertion hole 38 for receiving a screwdriver head 60 or a socket 70. A tool head 50 is mounted on the front shank 30, and has a first end formed with an insertion section 51 inserted into the insertion hole 38 of the front shank 30 and a second end formed with formed with an insertion hole 52 for insertion of the screwdriver head 60 or the socket 70.

The front shank 30 is formed with an axially extended receiving chamber 31. The receiving chamber 31 of the front shank 30 has a closed end having a top formed with a first space 310 and a bottom formed with a second space 311. The first space 310 of the receiving chamber 31 of the front shank 30 has an inner side formed with a notch 312.

The receiving chamber 31 of the front shank 30 has a bottom formed with a protruding guide rail 32. The guide rail 32 of the front shank 30 has an opened end formed with a dovetailed groove 33 and a locking hole 330 communicating with the dovetailed groove 33. A wedge-shaped push block 34 is mounted on the guide rail 32 of the front shank 30, and has a dovetailed seat 35 inserted into the dovetailed groove 33 of the guide rail 32 of the front shank 30. The dovetailed seat 35 of the push block 34 has a first end formed with a protruding rod 350 inserted into the locking hole 330 of the guide rail 32 of the front shank 30 and a second end formed with an elastic key 351. The push block 34 is formed with a transverse through hole 340 for receiving two positioning balls 37 and a spring 36 urged between the two positioning balls 37.

The rear shank 40 is mounted on the front shank 30, and has a receiving seat 41 inserted into the receiving chamber 31 of the front shank 30. The receiving seat 41 of the rear shank 40 has a distal end formed with a first lug 410 inserted into the first space 310 of the receiving chamber 31 of the front shank 30 and a second lug 411 inserted into the second space 311 of the receiving chamber 31 of the front shank 30. The first lug 410 of the receiving seat 41 of the rear shank 40 has an inner side formed with a locking rib 415 locked in the notch 312 of the first space 310 of the front shank 30. The first lug 410 of the receiving seat 41 of the rear shank 40 has an outer side formed with a receiving recess 416 for receiving a spring 412 and a positioning ball 413 rested on a top of the spring 412 and urged on the wall of the receiving chamber 31 of the front shank 30. The receiving seat 41 of the rear shank 40 is formed with a plurality of receiving holes 42 for receiving the screwdriver heads 60 and the sockets 70.

The receiving seat 41 of the rear shank 40 has a bottom formed with a slideway 43 slidably mounted on the guide rail 32 of the front shank 30 and communicated with the plurality of receiving holes 42. The slideway 43 of the receiving seat 41 of the rear shank 40 has two closed ends to limit detachment of the guide rail 32 of the front shank 30, thereby preventing the rear shank 40 from detaching from the front shank 30. The slideway 43 of the receiving seat 41 of the rear shank 40 is formed with a plurality of positioning grooves 44 for locking the positioning ball 37 of the push block 34.

The rear shank 40 has one end formed with a positioning hole 414 located opposite to the second lug 411 for locking the elastic key 351 of the dovetailed seat 35 of the push block 34 when the rear shank 40 is retracted into the front shank 30.

In assembly, the slideway 43 of the rear shank 40 is initially mounted on the guide rail 32 of the front shank 30. Then, the dovetailed seat 35 of the push block 34 is inserted into the dovetailed groove 33 of the guide rail 32 of the front shank 30, and the protruding rod 350 of the dovetailed seat 35 of the push block 34 is inserted into the locking hole 330 of the guide rail 32 of the front shank 30, so that the push block 34 is secured on the guide rail 32 of the front shank 30. In such a manner, the slideway 43 of the rear shank 40 is slidable on the guide rail 32 of the front shank 30, so that the rear shank 40 is slidable on the front shank 30. In addition, the slideway 43 of the rear shank 40 has two closed ends to limit detachment of the guide rail 32 of the front shank 30, thereby preventing the rear shank 40 from detaching from the front shank 30.

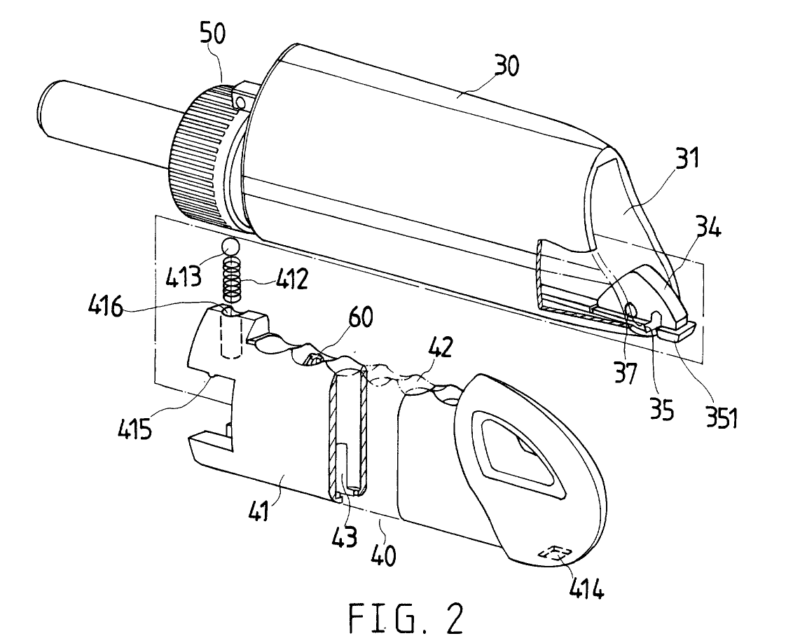

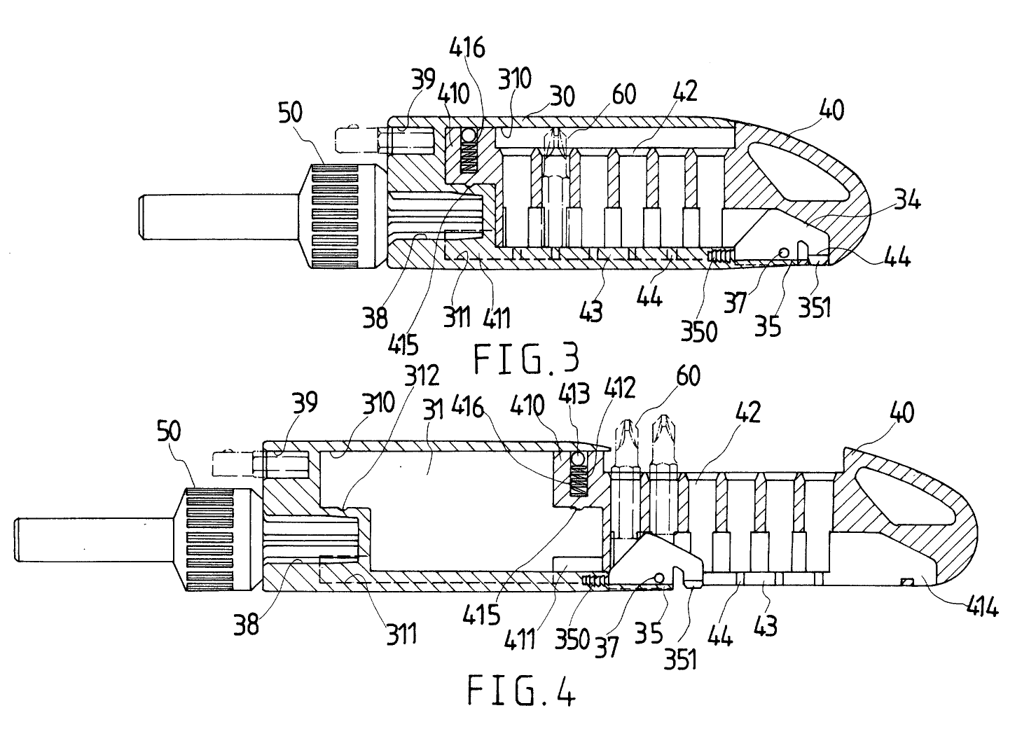

In operation, referring to FIGS. 3 and 4 with reference to FIGS. 1 and 2, when the receiving seat 41 of the rear shank 40 is retracted into the receiving chamber 31 of the front shank 30, the elastic key 351 of the dovetailed seat 35 of the push block 34 is locked in the positioning hole 414 of the rear shank 40, so that the rear shank 40 is secured on the front shank 30 as shown in FIG. 3. The user exerts a force to pull the rear shank 40 to release from the front shank 30, so that the rear shank 40 is moved outward relative to the front shank 30, thereby exposing the screwdriver heads 60 and the sockets 70 as shown in FIG. 4.

At this time, the slideway 43 of the rear shank 40 is slidable on the guide rail 32 of the front shank 30 and slidable on the push block 34. Thus, when one of the plurality of receiving holes 42 of the receiving seat 41 of the rear shank 40 aligns with the push block 34, the screwdriver head 60 or the socket 70 received in the respective receiving hole 42 is pushed upward by the push block 34, thereby facilitating the user taking and using the screwdriver head 60 or the socket 70.

In addition, each of the plurality of positioning grooves 44 of the rear shank 40 is used for positioning the positioning ball 37 of the push block 34, thereby positioning the rear shank 40 on the front shank 30 temporarily.

Further, the receiving seat 41 of the rear shank 40 is formed with a plurality of receiving holes 42 for receiving the screwdriver heads 60 and the sockets 70, thereby enhancing the storage space of the screwdriver handle.

Further, the slideway 43 of the rear shank 40 has two closed ends to limit detachment of the guide rail 32 of the front shank 30, thereby preventing the rear shank 40 from detaching from the front shank 30.

Further, the positioning ball 413 of the first lug 410 of the rear shank 40 is urged on the wall of the receiving chamber 31 of the front shank 30, thereby preventing the rear shank 40 from detaching from the front shank 30.

Further, the first lug 410 and the second lug 411 of the rear shank 40 are rested on the wall of the receiving chamber 31 of the front shank 30, so that the rear shank 40 is slidable on the front shank 30 rigidly and stably, thereby facilitating operation of the user.

While the preferred embodiment(s) of the present invention has been shown and described, it will be apparent to those skilled in the art that various modifications may be made in the embodiment(s) without departing from the spirit of the present invention. Such modifications are all within the scope of the present invention.

What is claimed is:

1. A screwdriver handle having a storage structure, comprising a front shank, and a rear shank combined with the front shank, wherein:
the front shank is formed with an axially extended receiving chamber, the receiving chamber of the front shank has a bottom formed with a protruding guide rail; and
the rear shank is mounted on the front shank, and has a receiving seat inserted into the receiving chamber of the front shank, the receiving seat of the rear shank is formed with a plurality of receiving holes for receiving screwdriver heads and sockets, the receiving seat of the rear shank has a bottom formed with a slideway slidably mounted on the guide rail of the front shank and communicated with the plurality of receiving holes.

2. The screwdriver handle having a storage structure in accordance with claim 1, further comprising a wedge-shaped push block mounted on the guide rail of the front shank and aligned with one of the receiving holes of the receiving seat of the rear shank.

3. The screwdriver handle having a storage structure in accordance with claim 2, wherein the guide rail of the front shank has an opened end formed with a dovetailed groove and a locking hole communicating with the dovetailed groove, and the push block has a dovetailed seat inserted into the dovetailed groove of the guide rail of the front shank, the dovetailed seat of the push block has a first end formed with a protruding rod inserted into the locking hole of the guide rail of the front shank.

4. The screwdriver handle having a storage structure in accordance with claim 3, wherein the dovetailed seat of the push block has a second end formed with an elastic key, and the rear shank has one end formed with a positioning hole for locking the elastic key of the dovetailed seat of the push block when the rear shank is retracted into the front shank.

5. The screwdriver handle having a storage structure in accordance with claim 2, wherein the push block is formed with a transverse through hole for receiving two positioning balls and a spring urged between the two positioning balls, and the slideway of the receiving seat of the rear shank is formed with a plurality of positioning grooves for locking the positioning ball of the push block.

6. The screwdriver handle having a storage structure in accordance with claim 1, wherein the slideway of the receiving seat of the rear shank has two closed ends to limit detachment of the guide rail of the front shank, thereby preventing the rear shank from detaching from thefront shank.

7. The screwdriver handle having a storage structure in accordance with claim 1, wherein the front shank has an end face formed with a receiving hole for receiving a screwdriver head or a socket.

8. The screwdriver handle having a storage structure in accordance with claim 7, wherein the end face of the front shank is formed with an insertion hole located beside the receiving hole for insertion of an insertion section of a tool head.

9. The screwdriver handle having a storage structure in accordance with claim 1, wherein the receiving chamber of the front shank has a closed end having a top formed with a first space and a bottom formed with a second space, and the receiving seat of the rear shank has a distal end formed with a first lug inserted into the first space of the receiving chamber of the front shank and a second lug inserted into the second space of the receiving chamber of the front shank.

10. The screwdriver handle having a storage structure in accordance with claim 9, wherein the first space of the receiving chamber of the front shank has an inner side formed with a notch, and the first lug of the receiving seat of the rear shank has an inner side formed with a locking rib locked in the notch of the first space of the front shank.

11. The screwdriver handle having a storage structure in accordance with claim 1, wherein the first lug of the receiving seat of the rear shank has an outer side formed with a receiving recess for receiving a spring and a positioning ball rested on a top of the spring and urged on the wall of the receiving chamber of the front shank.
